(19) United States
(12) Patent Application Publication
(10) Pub. No.: US 2007/0132549 A1
(43) Pub. Date: Jun. 14, 2007

(54) Method and device for verifying owner of article

(75) Inventors: Hideki Ichikawa, Kawasaki (JP); Makoto Goda, Kawasaki (JP); Masaharu Minowa, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/393,682

(22) Filed: Mar. 31, 2006

(30) Foreign Application Priority Data
Dec. 14, 2005 (JP) 2005-360852

(51) Int. Cl. G05B 19/00

(52) U.S. Cl. 340/5.8; 340/572.1; 340/10.1

(57) ABSTRACT

A manufacturer of an article generates a keyword, and electromagnetically writes the keyword into an RFID and prints the keyword on a guarantee card. The RFID tag is then affixed to the article, and the article is packed along with the guarantee card and shipped. When making a sale, a retail store hands over the guarantee card to a customer who buys the article. When the customer wishes to sell the article, a purchasing store reads the keyword written to the RFID tag affixed to the article and asks the customer to furnish the keyword. If the keyword furnished by the customer, by referring to the guarantee card, etc., is identical to the keyword read from the RFID tag, the customer is deemed a genuine owner of the article.

### BACKGROUND OF THE INVENTION

1. Field of the Invention

The present invention relates to a technology for verifying whether a person is the genuine owner of an article.

2. Description of the Related Art

Shops dealing in used goods such as books, articles of clothing, electrical gadgets, etc., have always existed. On the one hand, the market for used goods has a positive use in that resources are efficiently utilized, while on the other hand, the same can be abused in that stolen articles can be transacted.

A technology is disclosed in Japanese Patent Laid-Open Publication No. 2004-234403 by which it can be determined whether an article that ends up in a used goods shop has been acquired by an improper means. In this technology, ID data affixed to a book and a circulation status of the book are correlated and stored in a remote database. When a bookstore or a secondhand bookstore intends to purchase this book, the database is inquired to verify that the book does not have a dubious history.

However, in the conventional technology, a database having a large amount of data must be set up and maintained, and a network is required for inquiring the database. Consequently, there is a huge cost factor involved.

### SUMMARY OF THE INVENTION

It is an object of the present invention to at least solve the problems in the conventional technology.

According to an aspect of the present invention, a method of verifying whether a person is a genuine owner of an article includes reading electromagnetically a first keyword stored in an RFID tag any one of built into and affixed externally to an article; receiving a second keyword from the person; and comparing the first keyword and the second keyword, and determining that the person is a genuine owner of the article if the first keyword and the second keyword are identical.

According to another aspect of the present invention, a device for verifying whether a person is a genuine owner of an article includes a keyword reading unit that electromagnetically reads a first keyword stored in an RFID tag any one of built into and affixed externally to an article; a keyword inputting unit that accepts input of a second keyword from the person; and an authenticating unit that compares the first keyword and the second keyword, and determines that the person is a genuine owner of the article if the first keyword and the second keyword are identical.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an overview of an owner verification method according to a first embodiment of the present invention;

FIG. 2 is a schematic of an example of data written to an RFID tag shown in FIG. 1;

FIG. 3 is a flowchart of a process procedure performed at a manufacturer end;

FIG. 4 is a flowchart of a process procedure performed at a purchasing store;

FIG. 5 is a function block diagram of an owner verification device according to the first embodiment;

FIG. 6 is a flowchart of a process procedure performed by the owner verification device;

FIG. 7 is a schematic for explaining an overview of a owner verification method according to a second embodiment of the present invention;

FIG. 8 is a schematic of an example of the data written to a RFID tag shown in FIG. 7;

FIG. 9 is a flowchart of a process procedure performed at a retail store;

FIG. 10 is a flowchart of the process procedure performed at the purchasing store;

FIG. 11 is a block diagram of a owner verification device according the second embodiment;

FIG. 12 is a flowchart of a process procedure performed by the owner verification device shown in FIG. 11; and

FIG. 13 is a flowchart of another process procedure performed by the owner verification device shown in FIG. 11.

### DETAILED DESCRIPTION OF THE PREFERRED EMBODIMENTS

Exemplary embodiments of the present invention are explained next with reference to the accompanying drawings.

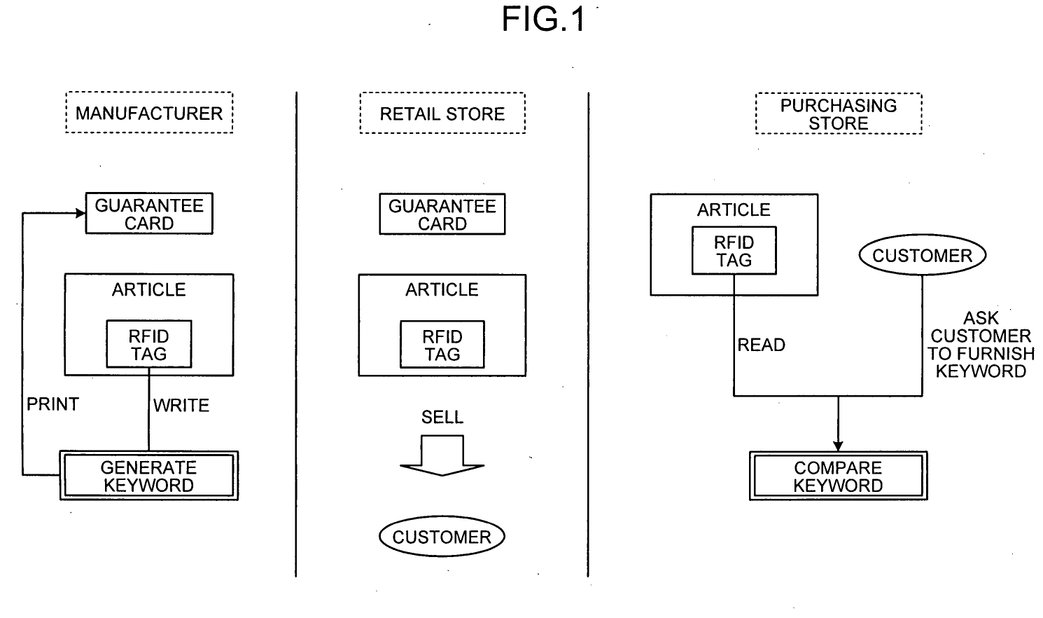

An overview of the owner verification method according to a first embodiment of the present invention is explained first. FIG. 1 is a schematic for explaining the overview of the owner verification method according to the first embodiment. In the owner verification method according to the first embodiment, a radio frequency identification (RFID) tag is affixed to an article. The RFID tag, from which data can be read and to which data can be written, is used for owner verification.

The RFID tag is also known as an IC tag and includes an IC chip for storing data and an antenna for wireless communication. Data is read from or written to the RFID tag by a device known as a reader/writer. The reader/writer reads data from or writes data to by a non-contact method. Any means that allows data reading and writing can be affixed to the article instead of an RFID tag.

A manufacturer of the article generates a keyword, and writes the keyword to the RFID tag affixed to the article as well as prints the keyword on the guarantee card. The manufacturer then packs the article along with the guarantee card and ships it. The keyword should preferably be unique and is a random number of a designated number of digits.

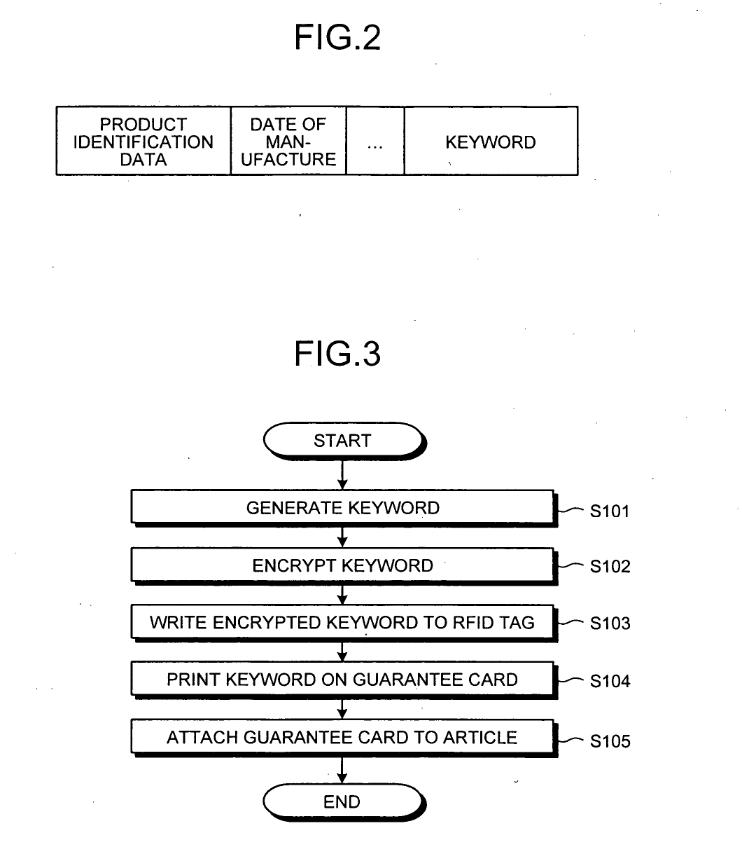

FIG. 2 is schematic of an example of the data written to the RFID tag. The data written to the RFID tag can include, apart from the keyword, product identification data such as serial number of the article, date of manufacture of the article, etc.

A retail store sells the article to a customer and the article along with the guarantee card is now in the possession of the customer. During the sale of the article, no change is made to the data in the RFID tag. However, data indicating that the article has been transacted by a legitimate deal can be added to the RFID tag during the sale of the article. This piece of data helps determine whether the article has been transacted by a legitimate deal when the article is brought to a purchasing store, such as a used goods shop.

When the article is brought in by the customer to the purchasing store with a view to selling it, the store employee reads the keyword written to the RFID tag affixed to the article and asks the customer to furnish the keyword. If the keyword furnished by the customer from the guarantee card is identical to the keyword read from the RFID tag, the store employee can be sure that the customer is the genuine owner of the article. If the two keywords are not identical, it can be surmised that there is a possibility that the article has been obtained by dubious means and the store can decline to purchase the article.

Thus, a unique keyword is invisibly embedded in the RFID tag affixed to the article and the same keyword is printed on the guarantee card of the article, so that only the genuine owner and the purchasing store are likely to know the keyword. Thus, the purchasing store can determine whether the person trying to sell the article is a genuine owner without requiring a database, network, etc.

To prevent reading keyword written to the RFID tag fraudulently, it is preferable to encrypt the keyword while writing to the RFID tag and only enable the purchasing store to decrypt the keyword.

The RFID tag can either be affixed externally on the article or can be built in. The RFID tag affixed externally can be easily read from and written to. An external RFID tag has an advantage in that it prevents theft from happening, as the RFID tag is visible and acts as a reminder for a prospective thief that the article in question has a feature for preventing unlawful dealings. A built-in RFID tag, on the other hand, has the advantage in that it cannot be damaged intentionally or replaced with another for fraudulent purposes.

The manufacturer need not necessarily print the keyword on the guarantee card and can adopt a method of conveying the keyword to the customer alone. This eliminates the possibility of anybody other than the customer getting hold of the keyword from the guarantee card. Further, instead of the manufacturer printing the keyword, the retail store employee can read the keyword of the article when making the sale and convey it to the customer.

The process procedures performed at the manufacturer end and the purchasing store are explained next. The process procedure performed at the retail store is like any normal sales procedure and hence is not described here.

FIG. 3 is a flowchart of the process procedure performed at the manufacturer end. The manufacturer generates a unique keyword for each article (step S101), encrypts the keyword (step S102), and writes the encrypted keyword to the RFID tag affixed to the article (step S103).

At the manufacturer end, the keyword is printed on the guarantee card (step S104) and the article with the guarantee card is shipped (step S105).

Encryption of the keyword and the writing of the encrypted keyword to the RFID tag can be realized by a reader/writer equipped with an encryption function. The process procedure described above need not follow that order. For instance, a batch of predetermined number of keywords can be generated and the printing of those keywords on the guarantee cards can be carried out beforehand, and then the rest of the steps can be carried out for each article.

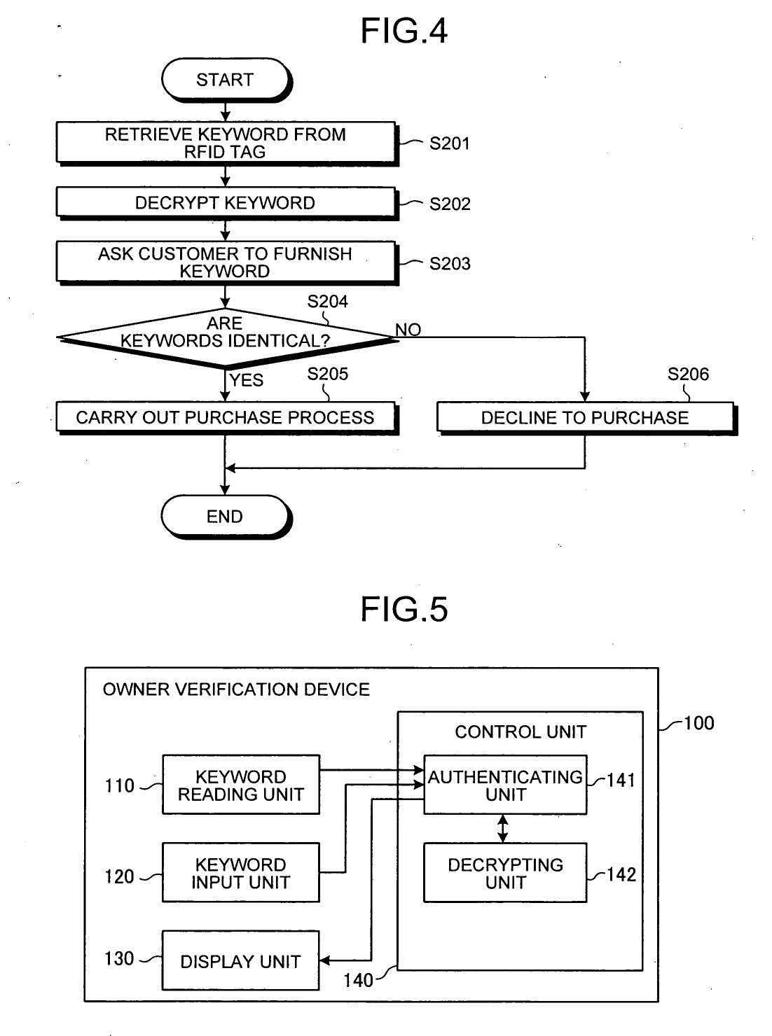

FIG. 4 is a flowchart of the process procedure at the purchasing store. At the purchasing store, the keyword from the RFID tag affixed to the article is read (step S201), and decrypted (step S202).

The customer, that is, the bearer of the article, is asked to furnish the keyword (step S203). If the keyword furnished by the customer is identical to the decrypted keyword (“Yes” at step S204), a normal purchase process is carried out (step S205). Otherwise (“No” at step S205), the purchase of the article is declined (step S206).

Reading the keyword from the RFID tag and its decryption can be realized by a reader/writer equipped with a decryption function. A custom-built device can be used to make the process easier. A device for verifying whether the bearer of the article is the genuine owner of the article is described next.

FIG. 5 is function block diagram of an owner verification device 100 according to the first embodiment. The owner verification device 100 includes a keyword reading unit 110, a keyword input unit 120, a display unit 130, and a control unit 140.

The keyword reading unit 110 reads the keyword from the RFID tag affixed to the article, and may, for instance, be the reader/writer. The keyword input unit 120 accepts input of the keyword, and may, for instance, be a keypad. The display unit 130 displays operation instructions, determination result, and may, for instance, be a liquid crystal display device.

The control unit 140 controls the entire owner verification device 100, and includes an authenticating unit 141 and a decrypting unit 142. The decrypting unit 142 decrypts the keyword.

The authenticating unit 141 performs a series of processes for verifying the genuineness of the owner of the article at the purchasing store. Specifically, the authenticating unit 141 prompts the decrypting unit 142 to decrypt the keyword read by the keyword reading unit 110, compares the decrypted keyword with the keyword input by the keyword input unit 120, and if they are identical, prompts the display unit 130 to display a “Purchase on” message, indicating that the purchase can go through, and if not, prompts the display unit 130 to display a “Purchase off” message, indicating that purchase be declined.

The owner verification device 100 can be provided as a part of another device, such as a cash register terminal, etc.

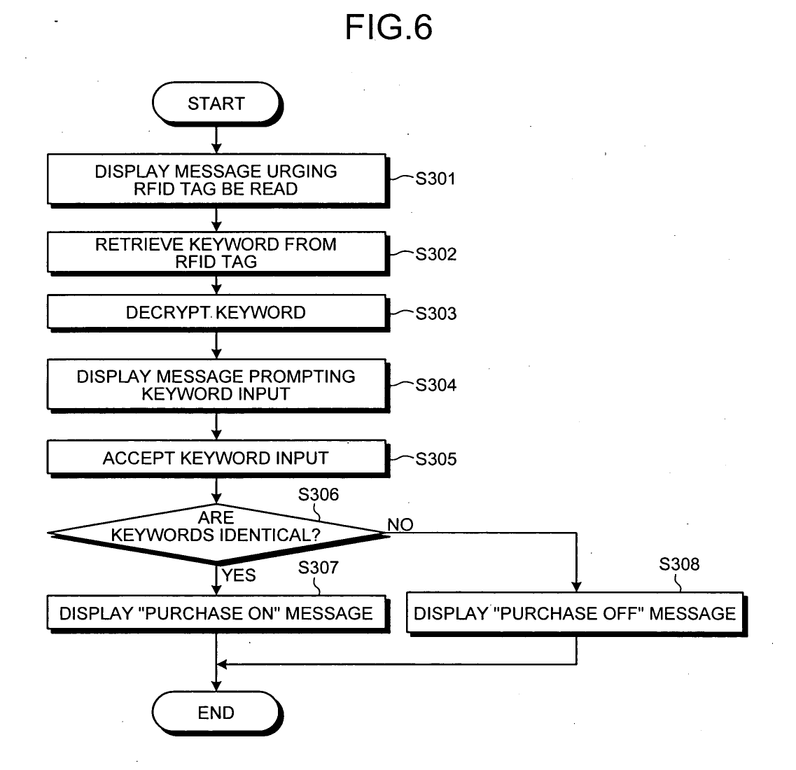

FIG. 6 is a flowchart of the process procedure performed by the owner verification device 100. When a request is made for owner verification, the authenticating unit 141 of the owner verification device 100 prompts the display unit 130 to display a message urging that the RFID tag be read (step S301). When the keyword reading unit 110 reads the keyword (step S302), the authenticating unit 141 prompts the decrypting unit 142 to decrypt the keyword (step S303).

The authenticating unit 141 prompts the display unit 130 to display a message prompting keyword input (step S304). When the keyword is input via the keyword input unit 120 (step S305), the authenticating unit 141 compares the decrypted keyword with the input keyword.

If the two keywords are identical (“Yes” at step S306), the authenticating unit 141 prompts the display unit 130 to display the “Purchase on” message (step S307), and otherwise (“No” at step S306), the “Purchase off” message (step S308).

The customer, that is, the bearer of the article, may input the keyword at step S305 or a store employee may enter it when the customer furnishes the keyword. Instead of printing the keyword on the guarantee card, the manufacturer may record the keyword in a recording medium such as an integrated circuit (hereinafter, “IC”) card. In such a case, a recording medium reading device may be used instead of the keyword input unit 120, and step S305 would involve reading of the recording medium.

The process procedures of the owner verification device 100 can also be realized by having a computer execute a ready owner verification program. The owner verification program has functions identical to those of the control unit 140 shown in FIG. 5. A processor of the computer reads the owner verification program from a storage device and executes it by launching it in the memory. The owner verification program can be stored on a recording medium such as a compact disk-Read-Only Memory (hereinafter, “CD-ROM”) or on another computer connected via a network.

Thus, according to the first embodiment, a unique keyword is invisibly embedded in the RFID tag affixed to the article so that only thee genuine owner and the purchasing store are likely to know the keyword. Thus, the purchasing store can determine whether the person trying to sell the article is a genuine owner without requiring a database, network, etc.

### Second Embodiment

In the first embodiment, a method for determining the authenticity of the owner of an article based on a keyword generated by the manufacturer. The keyword used in this method is a random string automatically generated at the manufacturer end and is difficult to memorize. If the guarantee card having the keyword printed thereon is lost, even the genuine owner will not be recognized as being one.

Therefore, a second embodiment of the owner verification method is explained next in which an owner of an article is recognized as being a genuine one even if he/she loses the guarantee card having the keyword printed thereon.

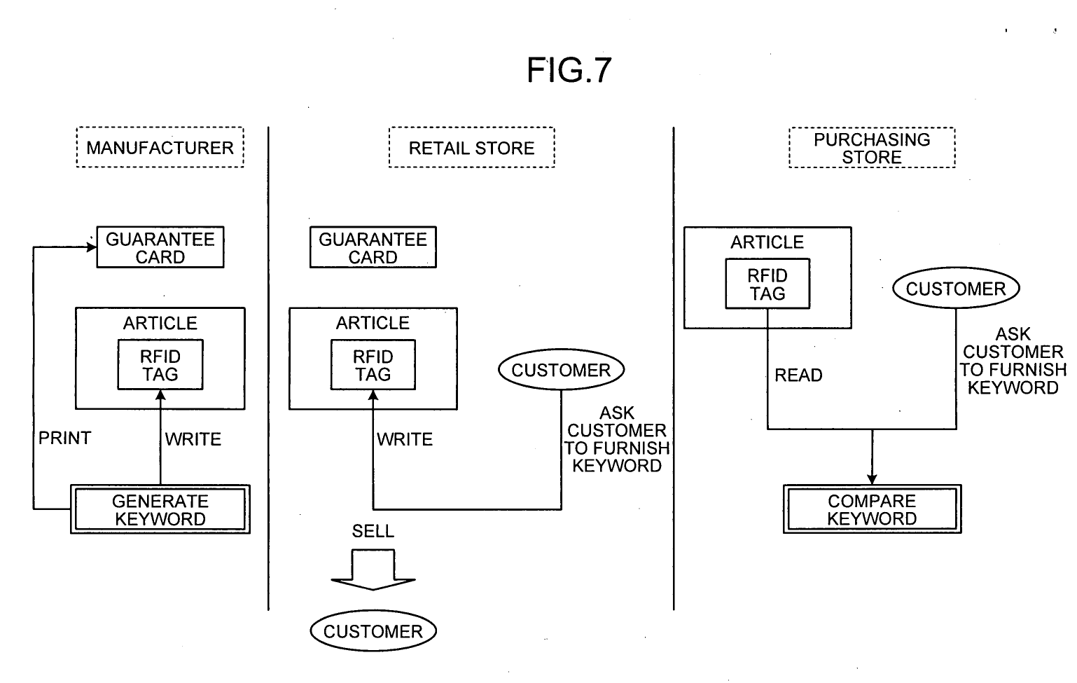

FIG. 7 is a schematic for explaining the overview of the owner verification method according to the second embodiment. The processes at the manufacturer end in the second embodiment are identical to those in the first embodiment. That is, the keyword is generated and written to the RFID tag affixed to the article as well as printed on the guarantee card. The manufacturer then packs the article along with the guarantee card and ships it.

At the retail store, when the article is being purchased by the customer, if the customer so wishes, the customer may furnish specific information, which is written as a keyword to the RFID tag affixed to the article. The specific information is information not likely to be known to anybody other than the customer.

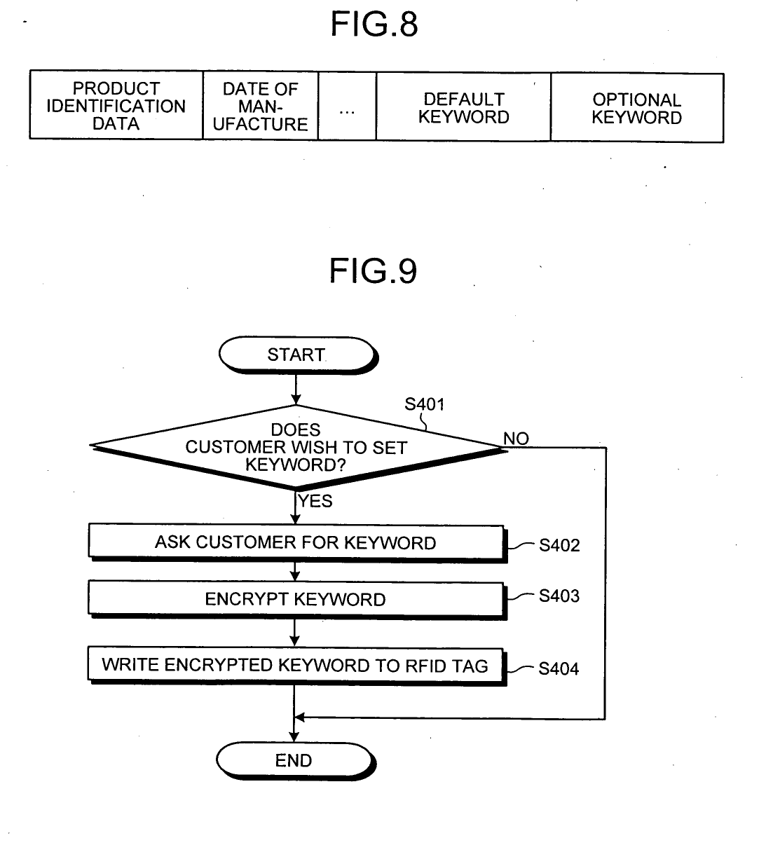

Specifically, the specific information may pertain to the customer's name, telephone number, date of birth, birthplace, school name, parent's maiden name, etc. FIG. 8 is schematic of an example of the data written to the RFID tag. The specific information obtained from the customer can be entered as optional keyword appendable to a default keyword. The default keyword is the keyword generated by the manufacturer.

When the article is brought in by the customer to the purchasing store with a view to selling it, the store employee reads the keyword written to the RFID tag affixed to the article and asks the customer to furnish the keyword. In this case, as the optional keyword is also written to the RFID tag, the store employee asks the customer to furnish the information entered in the optional keyword.

For example, if the place of birth is entered in the RFID tag, the store employee will ask the customer to furnish his/her birthplace. If the birthplace furnished by the customer is identical to the birthplace entered in the RFID tag, the customer is recognized as the genuine owner of the article and the article is deemed purchasable.

Thus, when the article is being purchased by the customer, information not likely to be known to anybody other than the customer is invisibly embedded in the RFID tag affixed to the article. When the article is brought into the purchasing store, the customer is asked to furnish the information embedded in the RFID tag. Thus, even if the customer loses the guarantee card bearing the keyword generated by the manufacturer, the store employee of the purchasing store can determine whether the customer is a genuine owner of the article based on the information he/she is able to furnish.

The retail store can embed in the RFID tag a plurality of optional keywords instead of one. The purchasing store can determine whether the customer is a genuine owner based on whether he/she provides the right answer to all of the questions, thus increasing the chances of catching a non-bonafide person posing as the owner of the article.

The manufacturer can do away with keyword generation, writing the keyword to the RFID tag and printing the keyword on the guarantee card altogether if the optional keyword is mandatorily written to the RFID tag when a sale of an article is made by the retail store.

The process procedures at the retail store and the purchasing store are explained next. The process procedure at the manufacturer end is like any normal sales procedure and hence is not described here.

FIG. 9 is a flowchart of the process procedure at the retail store. The customer is asked whether he/she wishes to set the optional keyword. If so (“Yes” at step S401), the customer is asked a specific question (step S402). The answer furnished by the customer is encrypted (step S403) and the encrypted keyword is written as the optional keyword to the RFID tag affixed to the article (step S404).

If the customer does not wish to set the optional keyword (“No” at step S401), no specific process is carried out. As the optional keyword pertains to personal information of the customer, it can lead to issues related to privacy. Therefore, there is an option of not setting the optional keyword and carrying out owner verification using only the default keyword generated by the manufacturer as in the first embodiment.

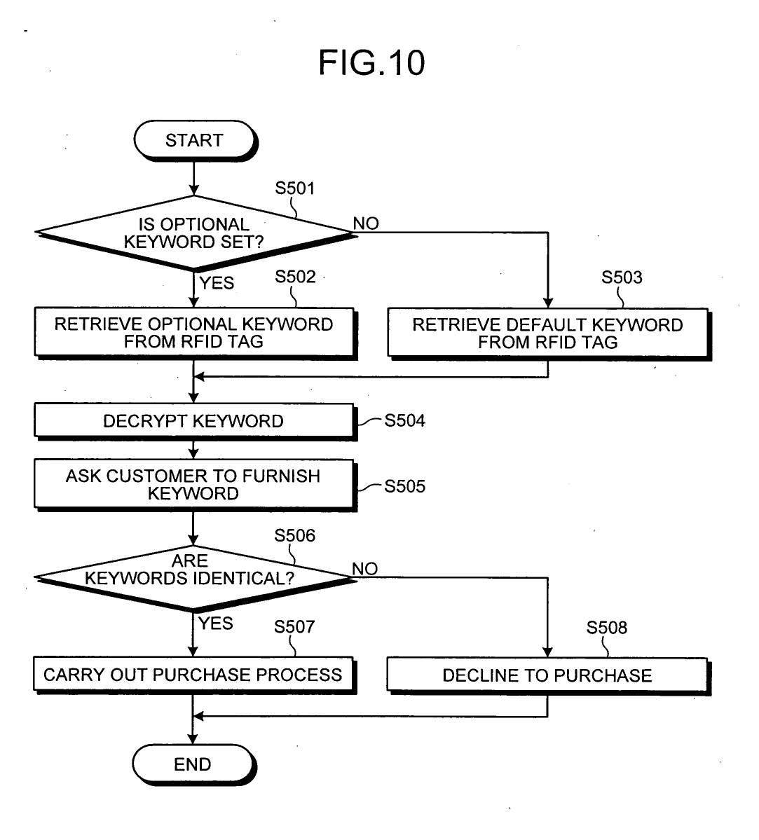

FIG. 10 is a flowchart of the process procedure at the purchasing store. At the purchasing store, the RFID tag affixed to the article is read, and if the optional keyword is set (“Yes” at step S501), the optional keyword is retrieved (step S502). If the optional keyword is not set (“No” at step S501), the default keyword is retrieved (step S503). The retrieved keyword is then decrypted (step S504).

The customer is asked the keyword (step S505). If the keyword provided by the customer is identical to the decrypted keyword (“Yes” at step S506), a normal purchase process is carried out (step S507). Otherwise (“No” at step S506), the purchase of the article is declined (step S508).

In the process procedures described above, the writing and reading of the keyword can be realized by a reader/writer equipped with an encryption/decryption function. A custom-built device can be used at the retail store and the purchasing store to make the process easier. A device for setting the optional keyword and verifying whether the bearer of the article is the genuine owner of the article is described next.

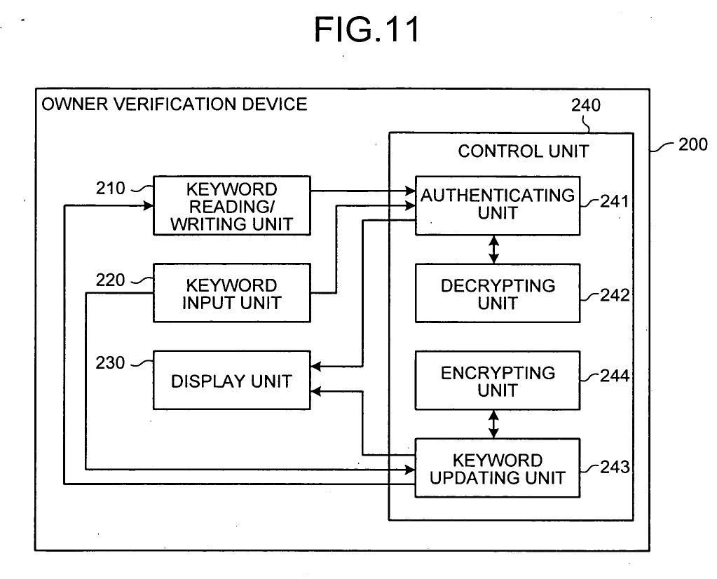

FIG. 11 is a block diagram of the owner verification device according to the second embodiment of the present invention. An owner verification device 200 includes a keyword reading/writing unit 210, a keyword input unit 220, a display unit 230, and a control unit 240.

The keyword reading/writing unit 210 reads the keyword from and writes the keyword to the RFID tag affixed to the article, and may, for instance, be a reader/writer. The, keyword input unit 220 accepts input of the keyword, and may, for instance, be a keypad. The display unit 230 displays operation instructions, determination result, and may, for instance, be a liquid crystal display device.

The control unit 240 controls the entire owner verification device 200, and includes an authenticating unit 241, a decrypting unit 242, a keyword updating unit 243, and an encrypting unit 244. The decrypting unit 242 decrypts the keyword. The encrypting unit 244 encrypts the keyword.

The authenticating unit 241 performs a series of processes for verifying the genuineness of the owner of the article at the purchasing store. Specifically, the authenticating unit 241 prompts the decrypting unit 242 to decrypt the keyword read by the keyword reading/writing unit 210, compares the decrypted keyword with the keyword input by the keyword input unit 220, and if they are identical, prompts the display unit 230 to display a “Purchase on” message, indicating that the purchase can go through, and if not, prompts the display unit 230 to display a “Purchase off” message, indicating that purchase be declined.

If the optional keyword is set in the RFID tag, the authenticating unit 241 treats the optional keyword as the keyword, and if no optional keyword is set, the authenticating unit 241 treats the default keyword as the keyword.

The keyword updating unit 243 performs a series of processes for setting the optional keyword at the purchasing store. Specifically, the keyword updating unit 243 prompts the encrypting unit 244 to encrypt the keyword input via the keyword input unit 220 and the keyword reading/writing unit 210 to write the keyword to the RFID tag.

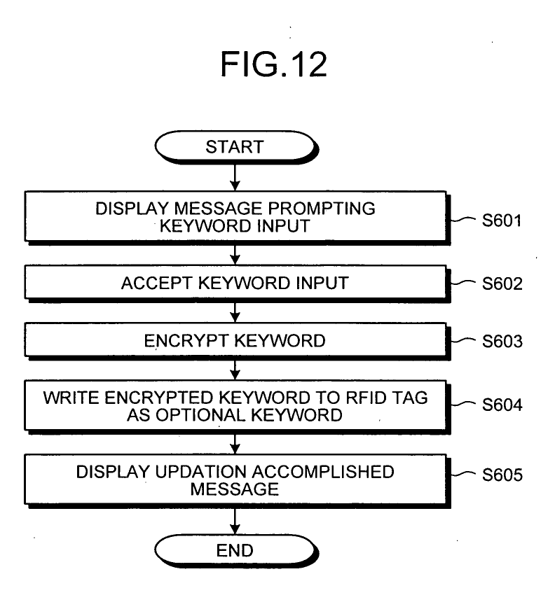

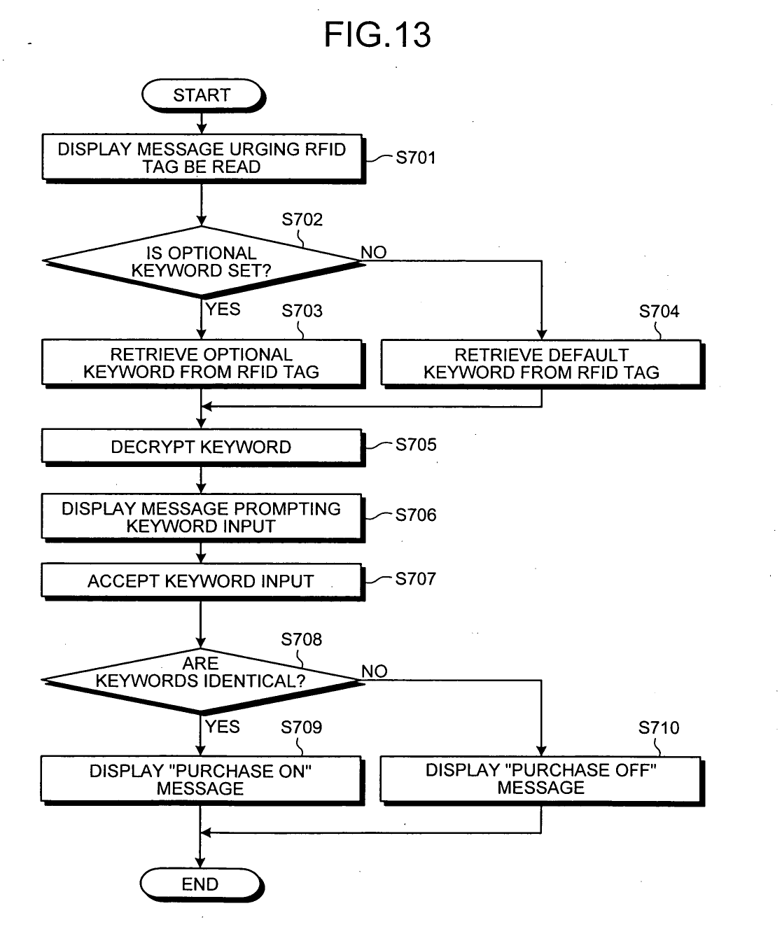

FIG. 12 and FIG. 13 are flowcharts of the process procedures of the owner verification device 200 shown in FIG. 11. FIG. 12 is a flowchart of the process procedure for setting the optional keyword at the retail store.

When a request is made for setting for the optional keyword, the keyword updating unit 243 of the owner verification device 200 prompts the display unit 230 to display a message prompting keyword input (step S601). When the keyword is input via the keyword input unit 220 (step S602), the keyword updating unit 243 prompts the encrypting unit 244 to encrypt the keyword (step S603).

The keyword updating unit 243 then instructs the keyword reading/writing unit 210 to write the encrypted keyword to the RFID tag as the optional keyword (step S604), and prompts the display unit 230 to display a message indicating that updation of keyword is accomplished (step S605).

FIG. 13 is a process procedure of owner verification performed at the purchasing store. When a request is made for owner verification, the authentication unit 241 of the owner verification device 200 prompts the display unit 230 to display a message urging that the RFID tag be read (step S701).

The keyword reading/writing unit 210 reads the contents of the RFID tag, and if the optional keyword is set (“Yes” at step S702), retrieves the optional keyword as the keyword (step S703). If the optional keyword is not set (“No” at step S702), the keyword reading/writing unit 210 retrieves the default keyword as the keyword (step S704). The authenticating unit 241 prompts the decrypting unit 242 to decrypt the retrieved keyword (sep S705).

The authenticating unit 241 prompts the display unit 230 to display a message prompting keyword input (step S706). When the keyword is input via the keyword input unit 220 (step S707), the authenticating unit 241 compares the decrypted keyword with the input keyword.

If the two keywords are identical (“Yes” at step S708), the authenticating unit 241 prompts the display unit 230 to display the “Purchase on” message (step S709), and otherwise (“No” at step S708), the “Purchase off” message (step S710).

Taking into account the fact that a retail store in some cases may double as a purchasing store, the owner verification device 200 according to the second embodiment is equipped with both optional password setting function and owner verification function. However, the owner verification device 200 can be provided only with one of these functions. The owner verification device 200 can be provided as a part of another device, such as a cash register terminal, etc.

The process procedure performed by the owner verification device 200 can also be realized by having a computer to execute a computer program (hereinafter, “owner verification program”. The owner verification program has functions identical to those of the control unit 240 shown in FIG. 11. A processor of the computer reads the owner verification program from a storage device and executes it by launching it in the memory. The owner verification program may be stored in a recording medium such as a CD-ROM or on another computer connected via a network.

Thus, according to the second embodiment, personal information likely to be known only to the customer is invisibly embedded as a keyword in the RFID tag affixed to the article when the article is purchased at the retail store, and the keyword can be read only at the purchasing store. Consequently, even if the customer loses the guarantee card of the article bearing the keyword generated by the manufacturer printed thereon, the purchasing store can determine whether the bearer of the article is a genuine owner of the article.

The embodiments of the owner verification method have been described here with a view to preventing unlawful dealings of articles. However, the application of the present invention is not restricted to prevention of unlawful dealings of articles and can be extended to any situation that requires the verification of the genuineness of the owner of an article.

According to an aspect of the present invention, if a keyword invisibly stored in an RFID tag affixed to an article and a keyword input by a bearer of the article are identical, the bearer of the article is deemed a genuine owner of the article. Consequently, owner verification can be performed by a simple structure without requiring a database or a network setup.

Moreover, the keyword is encrypted before being stored in the RFID tag. Consequently, a non-bonafide person posing as the owner of the article by reading the data stored in the RFID tag by fraudulent means can be prevented.

Furthermore, the keyword is stored in the RFID tag at the time of manufacture of the article. Consequently, it seldom happens that no keyword is set in the RFID tag of an article.

Moreover, the keyword is stored in the RFID tag when the article is sold. Consequently, information that is easy for the owner to remember can be stored as the keyword.

Furthermore, the owner's own personal information, such as owner's name, telephone number, or birthplace, and the like, is stored in the RFID tag as the keyword. Consequently, losing the keyword, such as in the case where the keyword is printed on a guarantee card and the guarantee card is lost, or forgetting the keyword can be avoided.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of verifying whether a person is a genuine owner of an article, the method comprising:
reading electromagnetically a first keyword stored in an RFID tag any one of built into and affixed externally to an article;
receiving a second keyword from the person; and
comparing the first keyword and the second keyword, and determining that the person is a genuine owner of the article if the first keyword and the second keyword are identical.

2. The owner verification method according to claim 1, further comprising encrypting the first keyword and storing encrypted first keyword in the RFID tag.

3. The method according to claim 1, further comprising storing the first keyword in the RFID tag at a time of manufacture of the article.

4. The method according to claim 1, further comprising storing the first keyword in the RFID tag at a time sale of the article.

5. The method according to claim 1, further comprising storing a name of the person as the first keyword in the RFID tag.

6. The method according to claim 1, further comprising storing a telephone number of the person as the first keyword in the RFID tag.

7. The method according to claim 1, further comprising storing a date of birth of the person as the first keyword in the RFID tag.

8. The method according to claim 1, further comprising storing a birthplace of the person as the first keyword in the RFID tag.

9. The method according to claim 1, further comprising storing a name of school of the person as the first keyword in the RFID tag.

10. The method according to claim 1, further comprising storing a maiden name of a parent of the person as the first keyword in the RFID tag.

11. A device for verifying whether a person is a genuine owner of an article, the owner verification device comprising:
a keyword reading unit that electromagnetically reads a first keyword stored in an RFID tag any one of built into and affixed externally to an article;
a keyword inputting unit that accepts input of a second keyword from the person; and
an authenticating unit that compares the first keyword and the second keyword, and determines that the person is a genuine owner of the article if the first keyword and the second keyword are identical.

12. The device according to claim 11, further including a decrypting unit that decrypts the first keyword read by the keyword reading unit, wherein
the authenticating unit compares decrypted first keyword and the second keyword.

13. The device according to claim 11, further including a keyword writing unit that electromagnetically stores the first keyword into the RFID tag.

14. The device according to claim 11, wherein the keyword writing unit stores a name of the person as the first keyword in the RFID tag.

15. The device according to claim 11, wherein the keyword writing unit stores a telephone number of the person as the first keyword in the RFID tag.

16. The device according to claim 11, wherein the keyword writing unit stores a date of birth of the person as the first keyword in the RFID tag.

17. The device according to claim 11, wherein the keyword writing unit stores a birthplace of the person as the first keyword in the RFID tag.

18. The device according to claim 11, wherein the keyword writing unit stores a name of school of the person as the first keyword in the RFID tag.

19. The device according to claim 11, wherein the keyword writing unit stores a maiden name of a parent of the person as the first keyword in the RFID tag.
